(19) United States
(12) Patent Application Publication
(10) Pub. No.: US 2026/0085826 A1
(43) Pub. Date: Mar. 26, 2026

(54) CHRISTMAS LAMP

(71) Applicant: Dongguan City is THE Art of Optoelectronic Technology Co., Ltd., Dongguan (CN)

(72) Inventor: FUDE YANG, Dongguan (CN)

(21) Appl. No.: 18/915,632

(22) Filed: Oct. 15, 2024

(30) Foreign Application Priority Data
Sep. 23, 2024 (CN) 202422315009.3

(51) Int. Cl. F21V 23/00; F21K 9/238; F21Y 115/10

(52) U.S. Cl. CPC F21V 23/004; F21K 9/238; F21Y 2115/10

(57) ABSTRACT

Disclosed is a Christmas lamp, including a lamp body consisting of an LED lamp, a PCB board, and a component; the LED lamp includes a lamp bead and a pin, the PCB board includes a substrate, first/second positive/negative copper foils and an insulating area, the second positive and negative copper foils are connected to the component, at least one of the first or the second positive copper foil is connected to a positive electrode of the pin, at least one of the first or the second negative copper foil is connected to a negative electrode of the pin, and the first/second positive and negative copper foils are all located on upper and lower sides of the substrate; and the first/second positive copper foil is separated from the first/second negative copper foil via the insulating area, and the first positive/negative copper foil is electrically connected to the second positive/negative copper foil.

### CROSS-REFERENCE TO RELATED APPLICATIONS

This application claims priority to Chinese Patent Application No. 202422315009.3, filed on September 23, 2024, which is hereby incorporated by reference in its entirety.

### TECHNICAL FIELD

The present disclosure belongs to the technical field of light-emitting diodes (LEDs), and particularly relates to a Christmas lamp.

### BACKGROUND

As a commonly used light-emitting device, light-emitting diode, LED for short, can emit light by releasing energy through the recombination of electrons and holes, and is widely used in the lighting industry. Generally, a plurality of LEDs are connected in series to form a light string, which is used as a decorative item.

However, the existing LED light strings have the following problems in the production process:

1. Due to thin and soft features, pins of a LED lamp bead are easily displaced during soldering by equipment, resulting in cold solder joints. Therefore, the existing processing methods generally solder single LED lamp beads together manually, which is inefficient.

2. A circuit structure lacks auxiliary components. When one of the LEDs therein is damaged due to breakage, malfunction, or an open circuit of a series circuit, the entire light string cannot work.

3. The rectifier modules are scattered, which makes the material preparation cumbersome, assembly labor intensive, and prone to quality problems.

4. Soldering the rectifier modules is time consuming to identify wiring connection of each pin, the assembly of the rectifier modules is cumbersome, and the production efficiency is low, making it difficult to achieve automation or semi-automation in the process.

### SUMMARY

### (1) Technical problem to be solved

The present disclosure provides a Christmas lamp, so as to solve the technical problems mentioned in the background art.

### (2) Technical solution

The present disclosure provides a Christmas lamp, including a lamp body, where the lamp body includes an LED lamp, a PCB board, and a component; the LED lamp includes a lamp bead and a pin, the PCB board includes a substrate, a first positive copper foil, a second positive copper foil, a first negative copper foil, a second negative copper foil and an insulating area, the second positive copper foil and the second negative copper foil are connected to the component, at least one of the first positive copper foil and the second positive copper foil is connected to a positive electrode of the pin, at least one of the first negative copper foil and the second negative copper foil is connected to a negative electrode of the pin, the first positive copper foil and the second positive copper foil are located on upper and lower sides of the substrate, and the first negative copper foil and the second negative copper foil are also located on the upper and lower sides of the substrate; and the first positive copper foil is separated from the first negative copper foil via the insulating area, the second positive copper foil is also separated from the second negative copper foil via the insulating area, the first positive copper foil is electrically connected to the second positive copper foil, and the first negative copper foil is electrically connected to the second negative copper foil.

As a preferred technical solution, the first positive copper foil of the PCB board is connected to the positive electrode of the pin, the first negative copper foil is connected to the negative electrode of the pin, and the second positive copper foil and the second negative copper foil are connected to the component.

As a preferred technical solution, the PCB board further includes two through holes, the through holes consist of a first through hole and a second through hole, the positive electrode of the pin is inserted into the first through hole, the negative electrode of the pin is inserted into the second through hole, and a shape of the PCB board is similar to a shape of a lower end surface of the lamp bead.

As a preferred technical solution, the component is a diode or a resistor, a positive electrode of the diode is connected to the second positive copper foil, and a negative electrode of the diode is connected to the second negative copper foil.

As a preferred technical solution, the lamp body further includes wires, the wires are connected to the pin, the PCB board, the pin, part of the wires, and the lamp bead are all housed inside an insulating housing, and part of the lamp bead is exposed outside the insulating housing, such that emitted light can be effectively transmitted outward.

As a preferred technical solution, a rectifier circuit is further provided, the rectifier circuit includes a first rectifier group, a second rectifier group, an alternating current (AC) power source L, and an AC power source N, where the first rectifier group includes a first diode and a second diode, a positive electrode of the first diode is connected to the AC power source L, a positive electrode of the second diode is connected to the AC power source N, a negative electrode of the first diode is connected to a negative electrode of the second diode to form a first connection point; the second rectifier group includes a third diode and a fourth diode, a negative electrode of the third diode is connected to the AC power source L, a negative electrode of the fourth diode is connected to the AC power source N, and a positive electrode of the third diode is connected to a positive electrode of the fourth diode to form a second connection point; and a plurality of the lamp bodies are connected in series to form a light string, a positive electrode of the light string is connected to the first connection point, and a negative electrode of the light string is connected to the second connection point.

As a preferred technical solution, the rectifier circuit further includes a third rectifier group, the third rectifier group includes a fifth diode and a sixth diode, a positive electrode of the fifth diode is connected to the AC power source L, a positive electrode of the sixth diode is connected to the AC power source N, a negative electrode of the fifth diode is connected to a negative electrode of the sixth diode to form a third connection point, and the first rectifier group and the second rectifier group form one bridge rectifier circuit; and the second rectifier group and the third rectifier group form another bridge rectifier circuit.

As a preferred technical solution, the Christmas lamp has three wires on the whole, which are the AC power source L, the AC power source N, and the light string formed by the plurality of the lamp bodies connected in series.

As a preferred technical solution, the rectifier group at one end of the light string is connected to a plug or a socket, and the rectifier group at the other end of the light string is connected to a socket or a plug.

As a preferred technical solution, the LED lamp is a bidirectional LED.

Compared with the prior art, the present disclosure has the following beneficial effects:

1. By using the PCB board as an intermediate connection medium, a solderable area is increased. More importantly, as the solderable area increases, wicking effect of solder can overcome the problem of cold solder joints caused by pin misalignment due to thin and soft pins of the lamp bead, enabling large-scale production with soldering equipment, replacing manual soldering, greatly improving production efficiency and avoiding the cold solder joints, such that the yield rate is improved.

2. By forming the light string and the rectifier circuit that are connected by the wires during operation, the present disclosure significantly improves the convenience and accuracy of connection compared with the traditional method of connecting scattered parts one by one. Furthermore, an integrated module production is more conducive to the use of automated equipment, thereby replacing manual assembly, and greatly improving production efficiency.

3. By arranging a resistor/diode in parallel on the PCB board, when a single lamp head in a series circuit is damaged or an open circuit occurs, current can flow through the diode or the resistor, allowing other lamp heads to work normally.

Other features and advantages of the present disclosure will be described in detail in the following detailed description of embodiments.

### BRIEF DESCRIPTION OF DRAWINGS

FIG. 1 is a perspective view of an LED lamp according to the present disclosure.

FIG. 2 is a perspective view of a PCB board according to the present disclosure.

FIG. 3 is a front view of a PCB board according to the present disclosure.

FIG. 4 is a first perspective view of connection between a PCB board and an LED lamp according to the present disclosure.

FIG. 5 is a perspective view of a PCB board with through holes according to the present disclosure.

FIG. 6 is a front view of a PCB board with through holes according to the present disclosure.

FIG. 7 is a second perspective view of connection between a PCB board and an LED lamp according to the present disclosure.

FIG. 8 is a perspective view of packaging of an LED lamp body according to the present disclosure.

FIG. 9 is a first schematic diagram of connection of an LED lamp body according to the present disclosure.

FIG. 10 is a second schematic diagram of connection of an LED lamp body according to the present disclosure.

FIG. 11 is a first schematic diagram of a rectification process according to the present disclosure.

FIG. 12 is a second schematic diagram of a rectification process according to the present disclosure.

FIG. 13 is a schematic diagram of wire connections according to the present disclosure.

FIG. 14 is a schematic diagram of connection of a bidirectional LED according to the present disclosure.

FIG. 15 is a schematic diagram of connection of a bidirectional LED without component according to the present disclosure.

Reference numerals in the accompanying drawings: 1. LED lamp; 11. lamp bead; 12. pin; 2. PCB board; 21. substrate; 22. through hole; 221. first through hole; 222. second through hole; 23. first positive copper foil; 24. second positive copper foil; 25. first negative copper foil; 26. second negative copper foil; 27. insulating area; 3. lamp body; 31. insulating housing; 32. wire; 33. component; 4. rectifier circuit; 41. first rectifier group; 411. first diode; 412. second diode; 42. second rectifier group; 421. third diode; 422. fourth diode; 43. third rectifier group; 431. fifth diode; 432. sixth diode; 44. first connection point; 45. second connection point; 46. third connection point; 5. plug; 6. socket; 7. light string; 8. first LED; and 9. second LED.

### DESCRIPTION OF EMBODIMENTS

In order to make the objectives, technical solutions, and advantages of the embodiments of the present disclosure clearer, the technical solutions of the embodiments of the present disclosure will be described clearly and completely with reference to the accompanying drawings of the embodiments of the present disclosure. Apparently, the described embodiments are some, but not all, embodiments of the present disclosure. All other embodiments obtained by those of ordinarily skilled in the art based on the embodiments of the present disclosure without making creative efforts fall within the scope of protection of the present disclosure.

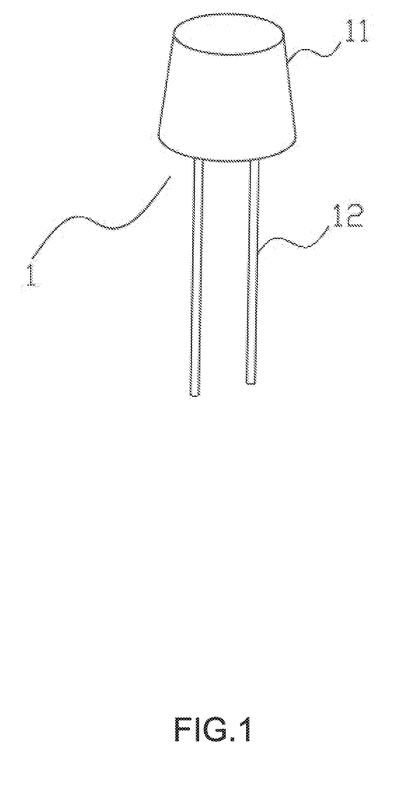

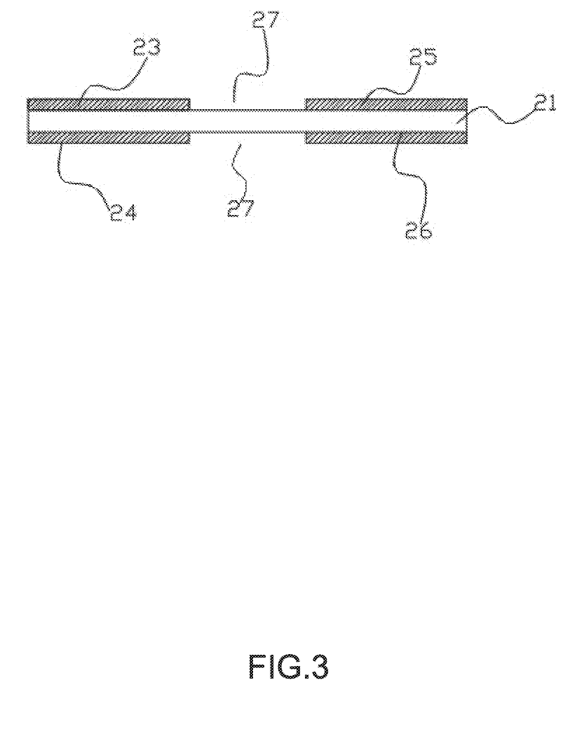

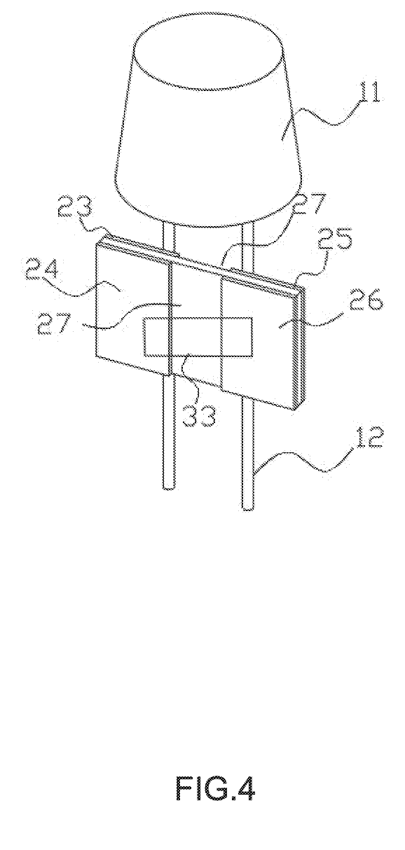

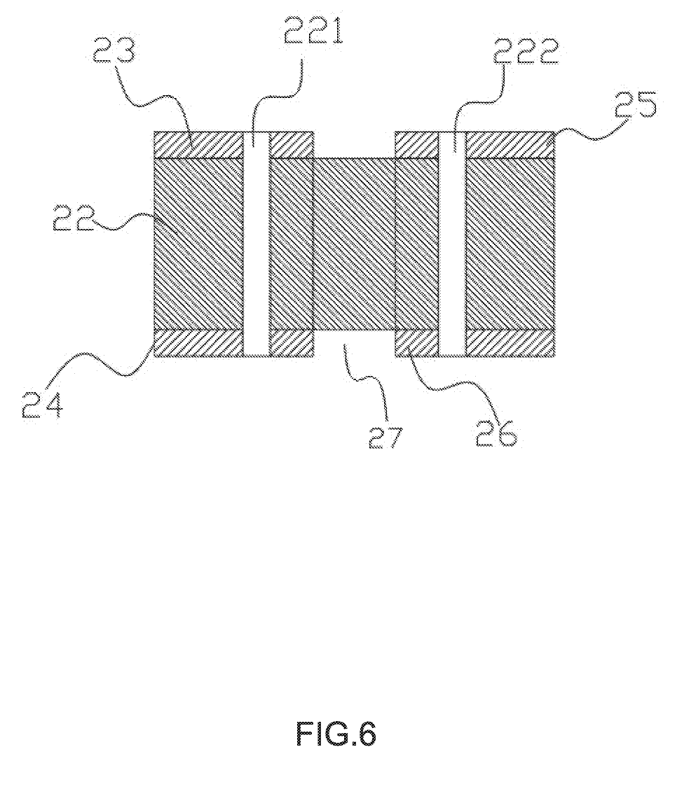

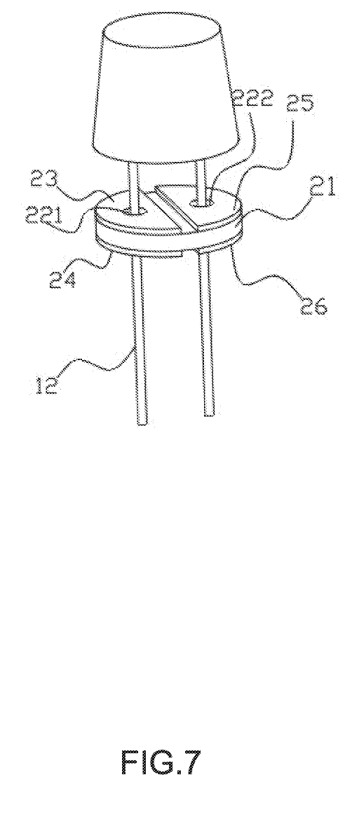

With reference to FIGS. 1-10, a Christmas lamp is provided, including a lamp body 3, where the lamp body 3 includes an LED lamp 1, a PCB board 2, and a component 33; the LED lamp 1 includes a lamp bead 11 and a pin 12, the PCB board 2 includes a substrate 21, a first positive copper foil 23, a second positive copper foil 24, a first negative copper foil 25, a second negative copper foil 26 and an insulating area 27, the second positive copper foil 24 and the second negative copper foil 26 are connected to the component 33, at least one of the first positive copper foil 23 and the second positive copper foil 24 is connected to a positive electrode of the pin 12, at least one of the first negative copper foil 25 and the second negative copper foil 26 is connected to a negative electrode of the pin 12, the first positive copper foil 23 and the second positive copper foil 24 are located on upper and lower sides of the substrate 21, and the first negative copper foil 25 and the second negative copper foil 26 are also located on the upper and lower sides of the substrate 21; and the first positive copper foil 23 is separated from the first negative copper foil 25 via the insulating area 27, the second positive copper foil 24 is also separated from the second negative copper foil 26 via the insulating area 27, the first positive copper foil 23 is electrically connected to the second positive copper foil 24, and the first negative copper foil 25 is electrically connected to the second negative copper foil 26. By using the PCB board as an intermediate connection medium, a solderable area is increased. As the solderable area increases, wicking effect of solder can overcome the problem of cold solder joints caused by pin misalignment due to thin and soft pins of the lamp bead, enabling large-scale production with soldering equipment, replacing manual soldering, greatly improving production efficiency and avoiding the cold solder joints, such that the yield rate is improved.

The PCB board 2 of the present disclosure offers two connection methods:

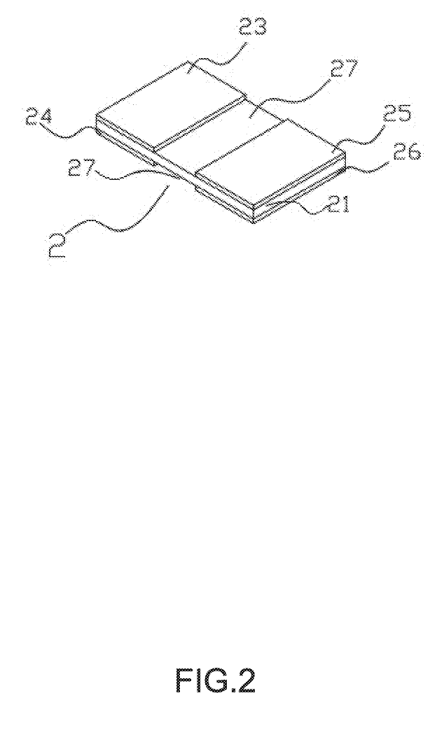

With reference to FIGS. 2-4, a first method is as follows: the first positive copper foil 23 of the PCB board 2 is connected to the positive electrode of the pin 12, and the first negative copper foil 25 is connected to the negative electrode of the pin 12, the second positive copper foil 24 and the second negative copper foil 26 are connected to component 33, and the connection method allows for side soldering.

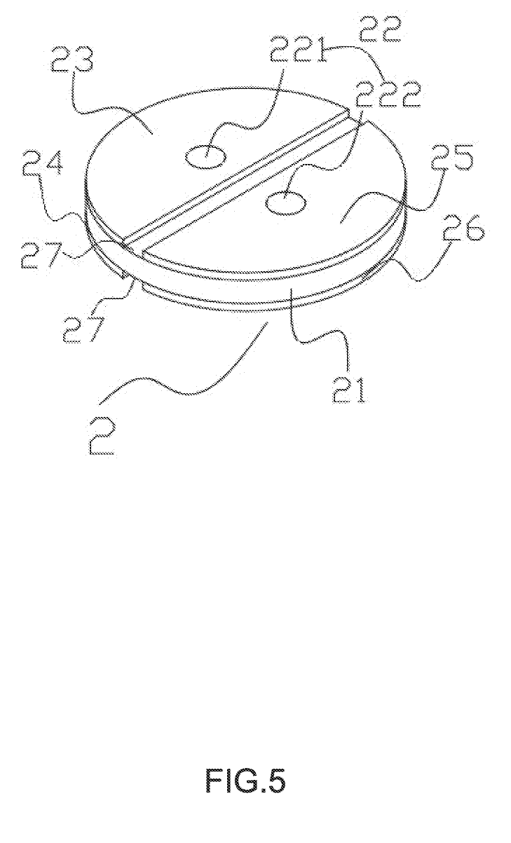

With reference to FIGS. 5-7, a second method is as follows: the PCB board 2 further includes through holes 22, the through holes 22 consist of a first through hole 221 and a second through hole 222, the positive electrode of the pin 12 is inserted into the first through hole 221, and the negative electrode of the pin 12 is inserted into the second through hole 222; a shape of the PCB board 2 is similar to a shape of a lower end surface of the lamp bead 11; and since injection molding glue is fluid during a molding process, a similarity in the shapes between the PCB board 2 and the lower end surface of the lamp bead 11 facilitates the molding process without adversely affecting a product.

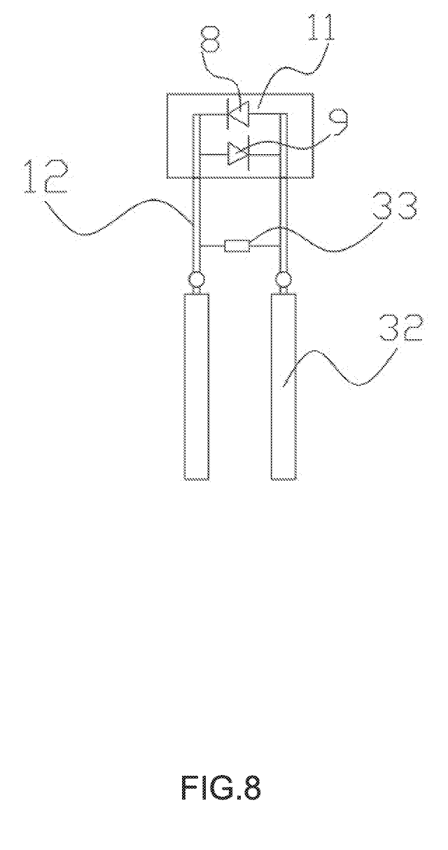

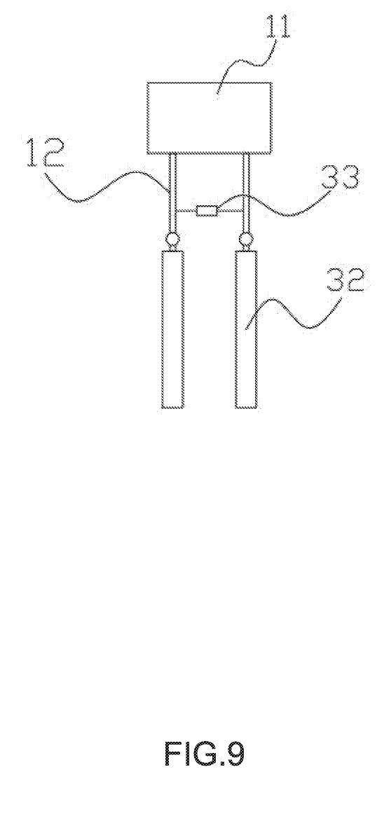

With reference to FIGS. 8 and 9, the component 33 is a diode or a resistor, a positive electrode of the diode is connected to the second positive copper foil 24, and a negative electrode of the diode is connected to the second negative copper foil 26. When a single lamp head in a series circuit is damaged or an open circuit occurs, current can flow through the diode or the resistor, allowing other lamp heads to work normally.

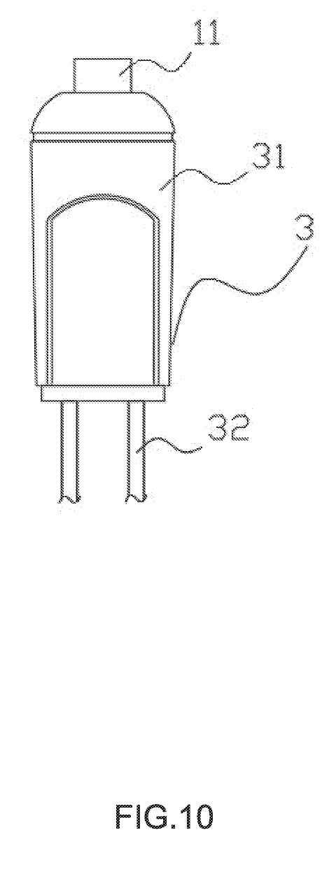

With reference to FIG. 10, the lamp body 3 further includes wires 32, the wires 32 are connected to the pin 12, the PCB board 2, the pin 12, part of the wires 32, and the lamp bead 11 are all housed inside an insulating housing 31, and part of the lamp bead 11 is exposed outside the insulating housing 31, such that emitted light can be effectively transmitted outward.

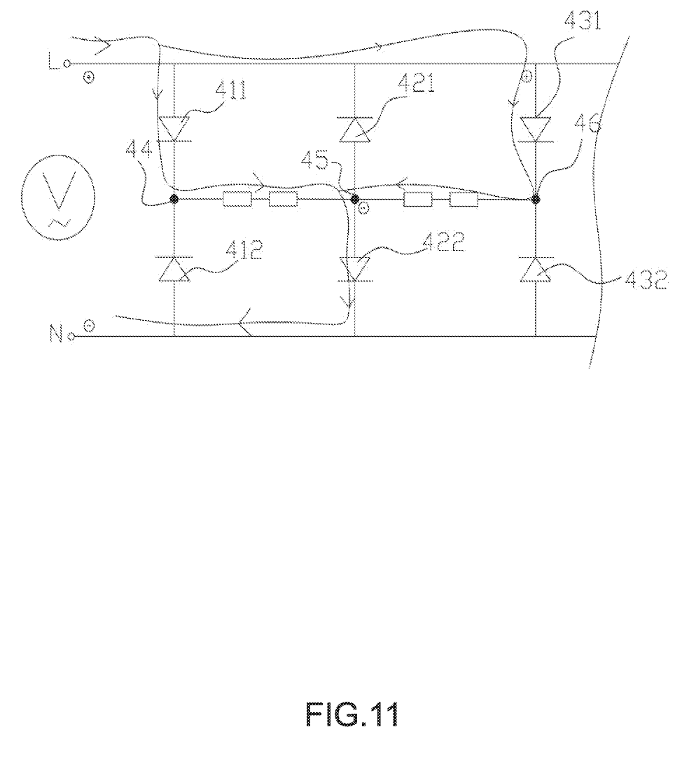

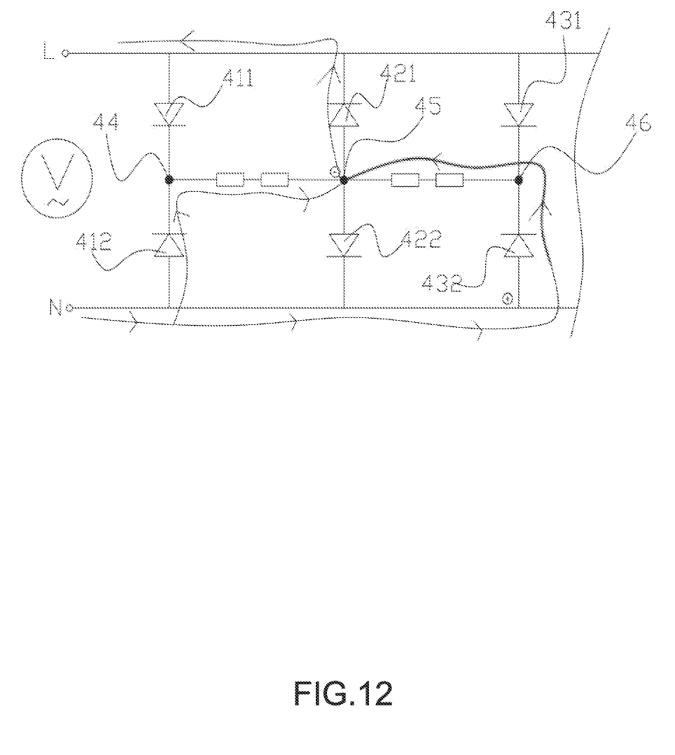

With reference to FIGS. 11-13, a rectifier circuit 4 is further provided, the rectifier circuit 4 includes a first rectifier group 41, a second rectifier group 42, an alternating current (AC) power source L, and an AC power source N, where the first rectifier group 41 includes a first diode 411 and a second diode 412, a positive electrode of the first diode 411 is connected to the AC power source L, a positive electrode of the second diode 412 is connected to the AC power source N, a negative electrode of the first diode 411 is connected to a negative electrode of the second diode 412 to form a first connection point 44; the second rectifier group includes a third diode 421 and a fourth diode 422, a negative electrode of the third diode 421 is connected to the AC power source L, a negative electrode of the fourth diode 422 is connected to the AC power source N, and a positive electrode of the third diode 421 is connected to a positive electrode of the fourth diode 422 to form a second connection point 45; and a plurality of the lamp bodies 3 are connected in series to form a light string 7, a positive electrode of the light string 7 is connected to the first connection point 44, and a negative electrode of the light string 7 is connected to the second connection point 45.

With reference to FIGS. 11-13, the rectifier circuit 4 further includes a third rectifier group 43, the third rectifier group 43 includes a fifth diode 431 and a sixth diode 432, a positive electrode of the fifth diode 431 is connected to the AC power source L, a positive electrode of the sixth diode 432 is connected to the AC power source N, a negative electrode of the fifth diode 431 is connected to a negative electrode of the sixth diode 432 to form a third connection point 46, and the first rectifier group 41 and the second rectifier group 42 form one bridge rectifier circuit; and the second rectifier group 42 and the third rectifier group 43 form another bridge rectifier circuit.

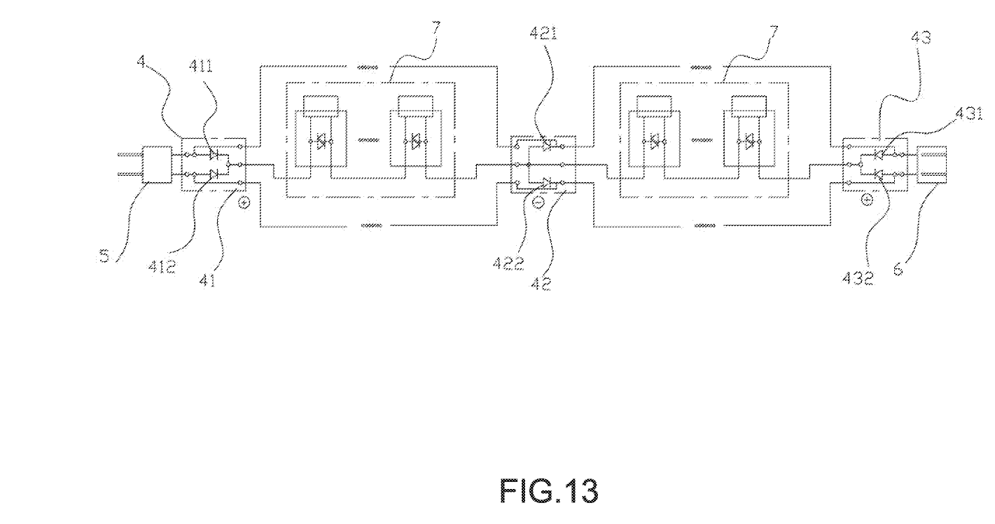

With reference to FIG. 13, the Christmas lamp has three wires on the whole, which are the AC power source L, the AC power source N, and the light string 7 formed by the plurality of the lamp bodies 3 connected in series, respectively.

With reference to FIG. 13, the rectifier group at one end of the light string 7 is connected to a plug 5 or a socket 6, and the rectifier group at the other end of the light string 7 is connected to a socket 6 or a plug 5. The plug 5 or the socket 6 can enable convenient installation and removal according to the required light string 7, and a number of the Christmas lamps can be adjusted as needed.

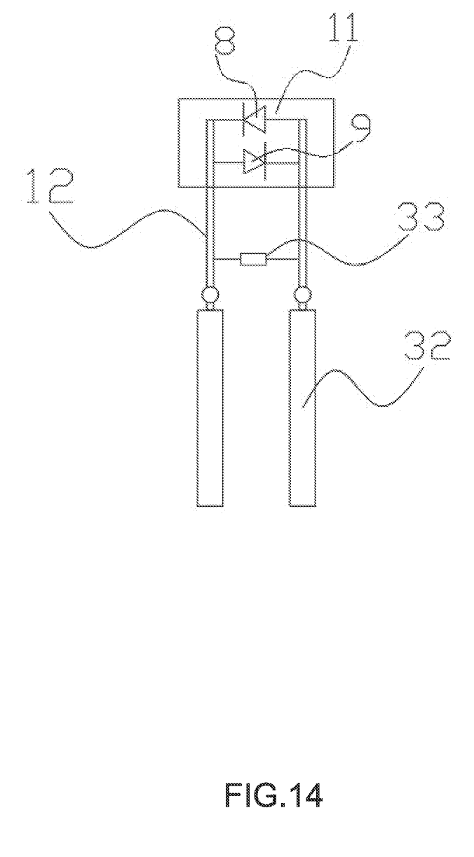

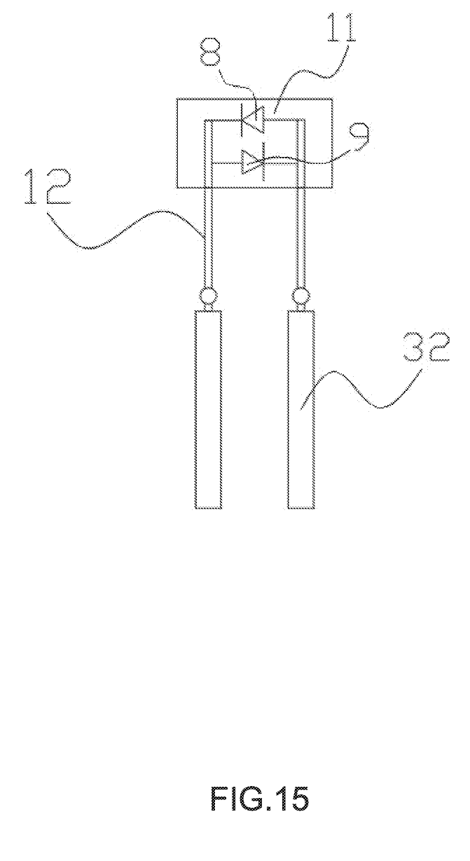

With reference to FIGS. 14 and 15, the present disclosure can be connected to the component 33, or can be disconnected to the component 33; the LED lamp 1 used can be a standard LED or a bidirectional LED, and when the bidirectional LED is used, no rectifier group is required. A first LED 8 and a second LED 9 are connected in parallel but in opposite directions. When a positive half-wave of AC current is conducted, the second LED 9 is turned on while the first LED 8 is turned off; and when a negative half-wave of the AC current is conducted, the first LED 8 is turned on while the second LED 9 is turned off.

By forming the light string 7 and the rectifier circuit 4 that are connected by the wires 32, the present disclosure significantly improves the convenience and accuracy of connection compared with the traditional method of connecting scattered parts one by one. Furthermore, an integrated module production is more conducive to the use of automated equipment, thereby replacing manual assembly, and greatly improving production efficiency.

Furthermore, it should be understood that although the description is described according to implementations, each implementation does not include only one independent technical solution, the description is for clarity only, and those skilled in the art should take the description as a whole, the technical solutions in the various embodiments may be appropriately combined to form other implementations understandable by those skilled in the art.

For those skilled in the art, it is apparent that the present disclosure is not limited to details of the exemplary embodiments, and the present disclosure can be implemented in other specific forms without departing from the spirit or basic features of the present disclosure. Therefore, the embodiments should be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure. Any reference numerals in the claims should not be construed as limiting the claims to which they relate.

What is claimed is:

1. A Christmas lamp, comprising a lamp body, wherein the lamp body comprises an LED lamp, a PCB board, and a component; the LED lamp comprises a lamp bead and a pin, the PCB board comprises a substrate, a first positive copper foil, a second positive copper foil, a first negative copper foil, a second negative copper foil and an insulating area, the second positive copper foil and the second negative copper foil are connected to the component, at least one of the first positive copper foil and the second positive copper foil is connected to a positive electrode of the pin, at least one of the first negative copper foil and the second negative copper foil is connected to a negative electrode of the pin, the first positive copper foil and the second positive copper foil are located on upper and lower sides of the substrate, and the first negative copper foil and the second negative copper foil are also located on the upper and lower sides of the substrate; and the first positive copper foil is separated from the first negative copper foil via the insulating area, the second positive copper foil is also separated from the second negative copper foil via the insulating area, the first positive copper foil is electrically connected to the second positive copper foil, and the first negative copper foil is electrically connected to the second negative copper foil.

2. The Christmas lamp according to claim 1, wherein the first positive copper foil of the PCB board is connected to the positive electrode of the pin, the first negative copper foil is connected to the negative electrode of the pin, and the second positive copper foil and the second negative copper foil are connected to the component.

3. The Christmas lamp according to claim 1, wherein the PCB board further comprises two through holes, the through holes consist of a first through hole and a second through hole, the positive electrode of the pin is inserted into the first through hole, the negative electrode of the pin is inserted into the second through hole, and a shape of the PCB board is similar to a shape of a lower end surface of the lamp bead.

4. The Christmas lamp according to claim 1, wherein the component is a diode or a resistor, a positive electrode of the diode is connected to the second positive copper foil, and a negative electrode of the diode is connected to the second negative copper foil.

5. The Christmas lamp according to claim 3, wherein the lamp body further comprises wires, the wires are connected to the pin, the PCB board, the pin, part of the wires, and the lamp bead are all housed inside an insulating housing, and part of the lamp bead is exposed outside the insulating housing, such that emitted light can be effectively transmitted outward.

6. The Christmas lamp according to claim 5, wherein a rectifier circuit is further provided, the rectifier circuit comprises a first rectifier group, a second rectifier group, an AC power source L, and an AC power source N, the first rectifier group comprises a first diode and a second diode, a positive electrode of the first diode is connected to the AC power source L, a positive electrode of the second diode is connected to the AC power source N, a negative electrode of the first diode is connected to a negative electrode of the second diode to form a first connection point; the second rectifier group comprises a third diode and a fourth diode, a negative electrode of the third diode is connected to the AC power source L, a negative electrode of the fourth diode is connected to the AC power source N, and a positive electrode of the third diode is connected to a positive electrode of the fourth diode to form a second connection point; and a plurality of the lamp bodies are connected in series to form a light string, a positive electrode of the light string is connected to the first connection point, and a negative electrode of the light string is connected to the second connection point.

7. The Christmas lamp according to claim 6, wherein the rectifier circuit further comprises a third rectifier group, the third rectifier group comprises a fifth diode and a sixth diode, a positive electrode of the fifth diode is connected to the AC power source L, a positive electrode of the sixth diode is connected to the AC power source N, a negative electrode of the fifth diode is connected to a negative electrode of the sixth diode to form a third connection point, and the first rectifier group and the second rectifier group form one bridge rectifier circuit; and the second rectifier group and the third rectifier group form another bridge rectifier circuit.

8. The Christmas lamp according to claim 6, wherein the Christmas lamp has three wires on the whole, which are the AC power source L, the AC power source N, and the light string formed by the plurality of the lamp bodies connected in series.

9. The Christmas lamp according to claim 7, wherein the rectifier group at one end of the light string is connected to a plug or a socket, and the rectifier group at the other end of the light string is connected to a socket or a plug.

10. The Christmas lamp according to claim 5, wherein the LED lamp is a bidirectional LED.
